(19) United States
(12) Patent Application Publication
(10) Pub. No.: US 2021/0379562 A1
(43) Pub. Date: Dec. 9, 2021

(54) RECOVERING SUPERABSORBENT POLYMERS

(71) Applicants: Kourosh Kabiri Bamoradian, Tehran (IR); Nasrin Moini, Tehran (IR); Mohammad Jalaloddin Zohuriaan-Mehr, Tehran (IR); Arash Jahandideh, Tehran (IR)

(72) Inventors: Kourosh Kabiri Bamoradian, Tehran (IR); Nasrin Moini, Tehran (IR); Mohammad Jalaloddin Zohuriaan-Mehr, Tehran (IR); Arash Jahandideh, Tehran (IR)

(73) Assignee: Iran Polymer and Petrochemical Institute, Tehran (IR)

(21) Appl. No.: 17/409,800

(22) Filed: Aug. 24, 2021

Related U.S. Application Data
(60) Provisional application No. 63/077,717, filed on Sep. 14, 2020.

(51) Int. Cl. B01J 20/30; B01J 20/32; B01J 20/28; B01J 20/26

(52) U.S. Cl. CPC B01J 20/3007; B01J 20/3287; B01J 20/28016; B01J 2220/68; B01J 20/3078; B01J 20/267; B01J 20/3282; B01J 20/28004

(57) ABSTRACT

A method for producing a cross-linked superabsorbent polymer for recycling superabsorbent polymers may be introduced. The method may include obtaining a solution by mixing a cross-linking agent, an initiator, water, acetone, and a functionalized oligomer. The method may further include obtaining a molded superabsorbent polymer by molding the superabsorbent polymer in a die. The superabsorbent polymer may include a polymer with a water absorbing capacity of more than 100 g/g. the method may further include impregnating the molded superabsorbent polymer with the solution by adding the solution to the molded superabsorbent polymer.

### CROSS-REFERENCE TO RELATED APPLICATION

This application claims the benefit of priority from pending U.S. Provisional Patent Application Ser. No. 63/077,717, filed on Sep. 14, 2020, and entitled “RECYCLING FINE SUPERABSORBENT POLYMER PARTICLES USING ACTIVE OLIGOMERS,” which is incorporated herein by reference in its entirety.

### TECHNICAL FIELD

The present disclosure relates to recovering superabsorbent polymers and more particularly relates to recovering superabsorbent polymers by oligomers.

### BACKGROUND

Wastes are unwanted or unusable materials created during an industrial process, such as electric power generation, water treatment, plastics and resins manufacturing, etc., which may be released into the environment. Wastes may include aqueous wastes and solid wastes. Aqueous wastes may be a mixture of hazardous organic substances, such as pesticides and petrochemicals with water and may endanger ground water quality and human health. Different materials, such as superabsorbent polymers may be used to absorb aqueous wastes and prevent their disposal into the environment.

Superabsorbent polymers are hydrophilic network of organic materials which can absorb and retain a huge amount of aqueous solutions. The annual production rate of superabsorbent polymers has increased exponentially due to the high demand for an aqueous-waste disposal. Exemplary superabsorbent polymers may include sodium polyacrylate, polyacrylamide copolymers, ethylene maleic anhydride copolymers, cross-linked carboxymethylcellulose, polyvinyl alcohol copolymers, cross-linked polyethylene oxides, and starch grafted copolymers of polyacrylonitrile. Superabsorbent polymer particles with an average particles size of more than 150 μm may be used for commercial applications and the usage of fine particles with an average particle size of less than 150 μm may be limited due to the production of dust and the adverse effect on the swelling capacity of the superabsorbent polymers. Superabsorbent polymers produced for absorbing aqueous wastes may contain fine particles with an average particle size of less than 150 μm which may be removed from the production process as a waste.

Different methods may be used to decrease superabsorbent wastes, for example, by modifying the process of grinding superabsorbent polymers in order to decrease the production of fine particles and crosslinking superabsorbent polymer particles. These strategies may decrease 5% to 10% of the total amount of the superabsorbent polymer particle waste worldwide. However, modifying the process of grinding superabsorbent polymers may require high financial demands. Cross-linking superabsorbent polymer particles may deteriorate swelling properties which may come from over crosslinking of superabsorbent polymer particles. Type of cross-linking agents may play an important role for the final properties of the superabsorbent polymer particles, such as the swelling capacity of the superabsorbent polymers. In addition, using non-recyclable cross-linking agents may endanger environmental health.

There is, therefore, a need for an environmentally-friendly and cost-effective method to recover fine particles of superabsorbent polymers. There is further a need for developing a method for producing a cross-linked superabsorbent polymer particle with a high swelling capacity.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a method for producing a cross-linked superabsorbent polymer. An exemplary method may include obtaining a solution by mixing a cross-linking agent, an initiator, water, acetone, and a functionalized oligomer. An exemplary method may further include obtaining a molded superabsorbent polymer by molding an exemplary superabsorbent polymer in a die. In an exemplary embodiment, an exemplary superabsorbent polymer may include a polymer with a water absorbing capacity of more than 100 g/g. In an exemplary embodiment, an exemplary method may further include impregnating an exemplary molded superabsorbent polymer with an exemplary solution by adding an exemplary solution to an exemplary superabsorbent polymer.

In an exemplary embodiment, mixing an exemplary cross-linking agent, an exemplary initiator, water, and an exemplary functionalized oligomer may include mixing an exemplary cross-linking agent, an exemplary initiator, water, acetone, and at least one of a citric acid-based oligomer and an epoxy acrylate oligomer.

In an exemplary embodiment, obtaining an exemplary solution may include mixing an exemplary cross-linking agent, an exemplary initiator, water, acetone, and an exemplary functionalized oligomer in a mixer with a rotational speed of between 100 rpm and 300 rpm for 15 minutes to 45 minutes.

In an exemplary embodiment, an exemplary solution may include mixing an exemplary cross-linking agent, an exemplary initiator, water, acetone, and an exemplary functionalized oligomer with a weight ratio of an exemplary initiator to an exemplary functionalized oligomer between 0.05:100 and 5:100 (initiator:functionalized oligomer).

In an exemplary embodiment, an exemplary solution may include mixing an exemplary cross-linking agent, an exemplary initiator, water, acetone, and an exemplary functionalized oligomer with a weight ratio of an exemplary cross-linking agent to an exemplary functionalized oligomer between 0.1:100 and 5:100 (cross-linking agent:functionalized oligomer).

In an exemplary embodiment, abating an exemplary solution may further include synthesizing functionalized oligomers by applying thermal energy and microwave radiation to exemplary reactants of an exemplary functionalized oligomer synthesis process.

In an exemplary embodiment, obtaining an exemplary solution may further include mixing an exemplary cross-linking agent, an exemplary initiator, water, acetone, and an exemplary functionalized oligomer with a catalyst. In an exemplary embodiment, an exemplary catalyst may include at least one of a para-toluene sulfonic acid, triphenylphosphine, a para-toluene sulfuric acid, and methyl imidazole.

In an exemplary embodiment, molding an exemplary superabsorbent polymer may include pouring an exemplary superabsorbent polymer with an average particle size of less than 150 μm into an exemplary die.

In an exemplary embodiment, molding an exemplary superabsorbent polymer may include obtaining an exemplary molded superabsorbent polymer with a thickness of between 1 mm and 20 mm.

In an exemplary embodiment, impregnating an exemplary molded superabsorbent polymer with an exemplary solution may include adding an exemplary solution to an exemplary molded superabsorbent polymer in a drop-wise manner with a weight ratio between 1:1 and 50:1 (molded superabsorbent polymer:an exemplary solution).

In an exemplary embodiment, impregnating molded superabsorbent polymer with an exemplary solution may include adding an exemplary solution to an exemplary molded superabsorbent polymer in a dropwise manner during a period in a range of 2 to 120 seconds.

In an exemplary embodiment, impregnating molded superabsorbent polymer with an exemplary solution may include adding an exemplary solution to an exemplary molded superabsorbent polymer with an addition rate of 0.1 mL/s to 3 mL/s.

In an exemplary embodiment, impregnating molded superabsorbent polymer with an exemplary solution may include impregnating an exemplary molded superabsorbent polymer with an exemplary solution for 5 minutes to 30 minutes.

In an exemplary embodiment, impregnating molded superabsorbent polymer with an exemplary solution may include heating an exemplary molded superabsorbent polymer and an exemplary functionalized oligomer in a range of 90° C. and 160° C.

In an exemplary embodiment, impregnating molded superabsorbent polymer with an exemplary solution may include heating an exemplary molded superabsorbent polymer and an exemplary functionalized oligomer for 5 minutes to 120 minutes.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example, it is expressly understood, however, that the drawings are for illustration and description only and are not intended as a definition of the limits of the present disclosure. Embodiments of the present disclosure will now be described by way of example in association with the accompanying drawings in which:

FIG. 1 illustrates a flowchart of a method for recovering superabsorbent polymers, consistent with one or more exemplary embodiments of the present disclosure;

FIG. 2 illustrates a schematic view of a die, consistent with one or more exemplary embodiments of the present disclosure;

FIG. 3 illustrates an attenuated total reflectance-Fourier transform infrared spectroscopy (ATR-FTIR) image of functionalized oligomers, consistent with one or more exemplary embodiments of the present disclosure;

FIG. 4 illustrates storage (G′) moduli of superabsorbent polymers interconnected by different functionalized oligomers, consistent with one or more exemplary embodiments of the present disclosure;

FIG. 5 illustrates loss (G″) moduli of superabsorbent polymers interconnected by different functionalized oligomers, consistent with one or more exemplary embodiments of the present disclosure;

FIG. 6 illustrates a damping factor of superabsorbent polymers interconnected by different functionalized oligomers, consistent with one or more exemplary embodiments of the present disclosure:

FIG. 7 illustrates a compressive stress versus a strain of superabsorbent polymers interconnected by different functionalized oligomers, consistent with one or more exemplary embodiments of the present disclosure;

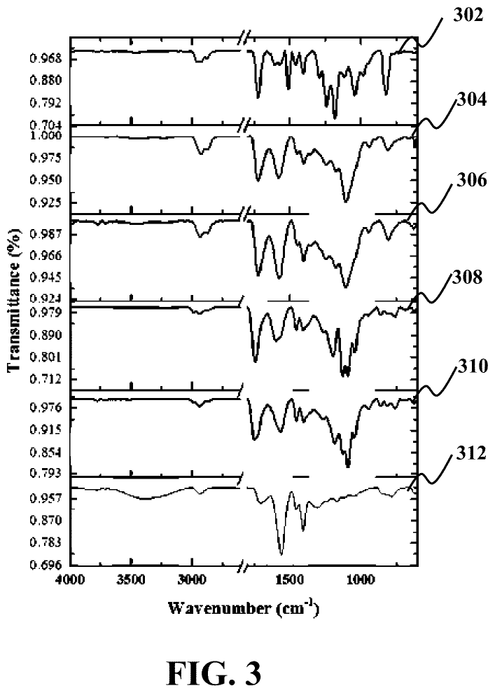

FIG. 3 illustrates optical microscope images of superabsorbent polymers interconnected by different functionalized oligomers, consistent with one or more exemplary embodiments of the present disclosure;

FIG. 9 illustrates optical microscope images of swollen and modified superabsorbent polymer particles, consistent with one or more exemplary embodiments of the present disclosure; and

FIG. 10 illustrates SEM images of functionalized superabsorbent polymer particles, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is generally directed to exemplary embodiments of a method for recovering fine superabsorbent polymers with an average particle size of less than 150 μm from superabsorbent polymer wastes. As used herein, an exemplary method for recovering fine superabsorbent polymers may refer to cross linking fine superabsorbent polymers to form a cross-linked superabsorbent polymer. Exemplary fine particles with an average particle size of less than 150 μm may produce dust and therefore may deteriorate the swelling capacity of the superabsorbent polymers. An exemplary method may include forming a solution by mixing a cross-linking agent, an initiator, water, acetone, and a functionalized oligomer in a mixer. An exemplary functionalized oligomer may include at least one of a lactic acid-based oligomer, a citric acid-based oligomer, and an epoxy acrylate oligomer which may be synthesized by applying thermal energy or microwave radiation. An exemplary lactic-acid based oligomer may be synthesized by applying thermal energy to exemplary reactants of an exemplary synthesis process of an exemplary lactic-acid based oligomer. An exemplary citric acid-based oligomer and an exemplary epoxy acrylate oligomer may be synthesized by applying microwave radiation to exemplary reactants of an exemplary synthesis process of an exemplary citric acid-based oligomer and an exemplary epoxy acrylate oligomer.

An exemplary method may further include pouring exemplary superabsorbent polymer particles into a die. A molded superabsorbent polymer may be formed after pouring exemplary superabsorbent polymer particles into an exemplary die with a thickness between 1 mm and 20 mm. An exemplary die may have a disc shape or a dumbbell shape.

After forming an exemplary molded superabsorbent polymer, an exemplary solution may be added dropwise to an exemplary molded superabsorbent polymer. An exemplary molded superabsorbent polymer may be exposed to an exemplary solution, such that all surface areas of an exemplary molded superabsorbent polymer may be exposed to an exemplary solution. After impregnating an exemplary molded superabsorbent polymer, an exemplary impregnated, superabsorbent polymer may be heated at a temperature between 90° C. and 160° C. Heating an exemplary impregnated superabsorbent polymer may enhance the formation of a chemical bond between an exemplary impregnated superabsorbent polymer and exemplary functional groups of exemplary functionalized oligomers. Therefore, cross-linking of an exemplary impregnated superabsorbent polymer and exemplary functionalized oligomers may enlarge an exemplary size of exemplary superabsorbent polymer particles. Exemplary fine superabsorbent polymer particles may produce dust and may have adverse effect on an exemplary swelling capacity of an exemplary superabsorbent polymer. Increasing an exemplary size of exemplary superabsorbent polymer particles may increase the swelling capacity of an exemplary superabsorbent polymer.

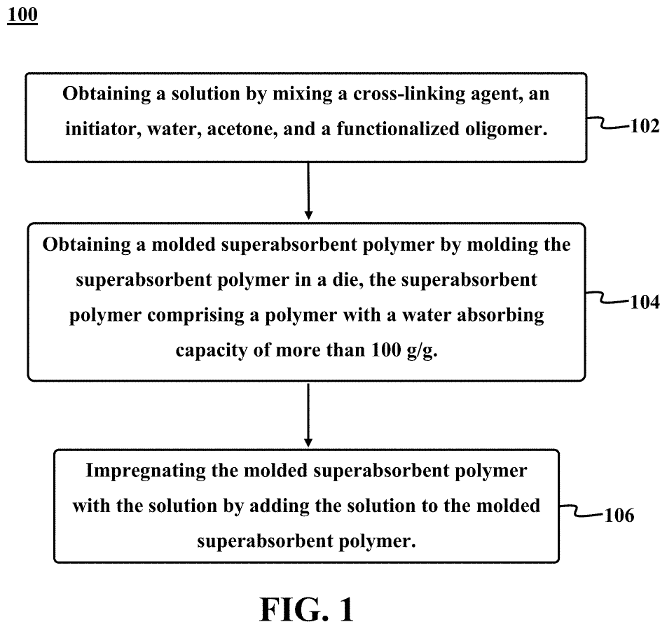

FIG. 1 illustrates a flowchart of a method 100 for recovering superabsorbent polymers, consistent with one or more exemplary embodiments of the present disclosure. In an exemplary embodiment, method 100 may include a step 102 of obtaining a solution by mixing a cross-linking agent, an initiator, water, acetone, and a functionalized oligomer, a step 104 of obtaining a molded superabsorbent polymer by molding the superabsorbent polymer in a die, the superabsorbent polymer comprising a polymer with a water absorbing capacity of more than 100 g/g, and a step 106 of impregnating the molded superabsorbent polymer with the solution by adding the solution to the molded superabsorbent polymer.

In an exemplary embodiment, step 102 of obtaining the solution may include synthesizing an oligomer. In an exemplary embodiment, an exemplary oligomer may be synthesized by adding reactants of an exemplary reaction produced during forming one of a lactic acid-based oligomer, a citric acid-based oligomer, and an epoxy acrylate oligomer into a mixer. An exemplary mixer may include rotating wings and a heater. In an exemplary embodiment, exemplary rotating wings may homogenously mix exemplary reactants disposed inside an exemplary mixer. In an exemplary embodiment, an exemplary lactic acid-based oligomer, an exemplary citric acid-based oligomer, and an exemplary epoxy acrylate oligomer may be synthesized by a chemical reaction activated by thermal energy or microwave radiation.

In an exemplary embodiment, step 102 of obtaining the solution may further include synthesizing an exemplary lactic acid-based oligomer by mixing L-lactic acid with glycerol in an exemplary mixer with a rotational speed of between 200 rpm and 900 rpm for 15 minutes to 60 minutes. In an exemplary embodiment, an exemplary mixture of L-lactic acid and glycerol may be heated at a temperature between 110° C. and 200° C., while mixing an exemplary mixture of L-lactic acid and glycerol in an exemplary mixer. In an exemplary embodiment, L-lactic acid may be added to glycerol with a weight ratio between 3:1 and 30:1 (L-lactic acid:glycerol). In an exemplary embodiment, a catalyst may also be added to an exemplary reaction mixture with a weight ratio of between 0.1:100 and 1:100 (catalyst:L-lactic acid), while mixing an exemplary mixture of L-lactic acid and glycerol. In an exemplary reaction between L-lactic acid and glycerol, water may be produced which then may be removed by adding a solvent. In an exemplary embodiment, an exemplary solvent may be mixed with an exemplary mixture of glycerol and L-lactic acid to dissolve water with a rotational speed of an exemplary mixer between 200 rpm and 750 rpm for 15 minutes to 180 minutes. In an exemplary embodiment, an exemplary solvent may be added to an exemplary mixture of glycerol and L-lactic acid with a weight ratio between 1:1 and 5:1 (solvent:L-lactic acid). In an exemplary embodiment, exemplary solvents may be removed from an exemplary reaction mixture by the evaporation at a temperature between 50° C. and 90° C. for 10 minutes to 150 minutes under vacuum pressure, utilizing for example, a rotary evaporator. As used herein, an exemplary rotary evaporator may refer to a device with a rotating round bottom flask and a condenser to effectively evaporate solvents. In an exemplary embodiment, glycerol may be the core of an exemplary lactic acid-based oligomer and L-lactic acid may be the branches of an exemplary lactic acid-based oligomer. In an exemplary embodiment, an exemplary lactic acid-based oligomer may have a star-shape structure. In an exemplary embodiment, an exemplary catalyst may include a para-toluene sulfuric acid (PTSA) and stannous octoate (Sn(Oct)₂). In an exemplary embodiment, an exemplary solvent may include tetrahydrofuran, dimethylformamide, m-xylene, toluene, methylene chloride, chlorobenzene, chloroform, and dimethyl sulfoxide. In an exemplary embodiment, an exemplary reaction of glycerol and L-lactic acid may be carried out under an inert atmosphere, such as nitrogen or argon.

In an exemplary embodiment, an exemplary lactic acid-based oligomer may also be functionalized by adding a functionalizing agent to an exemplary lactic acid-based oligomer to form a functionalized lactic acid-based oligomer. In an exemplary embodiment, an exemplary mixture of an exemplary functionalizing agent and an exemplary lactic acid-based oligomer may be mixed in an exemplary mixer with a rotational speed of between 450 rpm and 700 rpm for 10 minutes to ISO minutes under an inert atmosphere, such as nitrogen or argon. In an exemplary embodiment, an exemplary functionalizing agent and an exemplary lactic acid-based oligomer may be heated at a temperature between 90° C. and 150° C., while an exemplary functionalizing agent and an exemplary lactic acid-based oligomer may be mixed in an exemplary mixer. In an exemplary embodiment, while functionalizing lactic acid based-oligomer, methacrylic acid and water may be produced. In an exemplary embodiment, methacrylic acid and water may be removed film an exemplary reaction mixture by adding a solvent to an exemplary reaction mixture. In an exemplary embodiment, an exemplary solvent may dissolve methacrylic acid and water. In an exemplary embodiment, an exemplary mixture of methacrylic acid, water, and an exemplary solvent may be removed by the evaporation at a temperature between 50° C. and 90° C. for 10 minutes to 150 minutes under vacuum pressure, utilizing for example, a rotary evaporator. In an exemplary embodiment, an exemplary solvent may include tetrahydrofuran, dimethylformamide, m-xylene, toluene, methylene chloride, chlorobenzene, chloroform, and dimethyl sulfoxide. In an exemplary embodiment, an exemplary functionalizing agent may include methacrylic anhydride and acrylic acid. In an exemplary embodiment, an exemplary functionalizing agent may be added to an exemplary lactic acid-based oligomer with a weight ratio of between 1:3 and 1:30 (functionalizing agent: lactic acid-based oligomer). In an exemplary embodiment, an exemplary reaction between L-lactic acid and glycerol and an exemplary reaction between exemplary functionalizing agents and an exemplary lactic acid-based oligomer may be performed according to the following reactions:

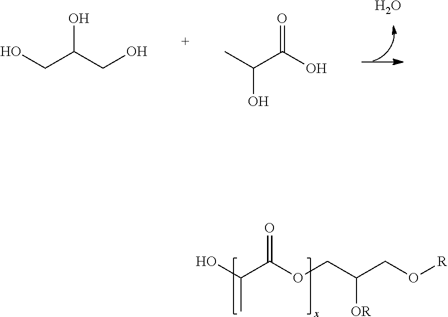

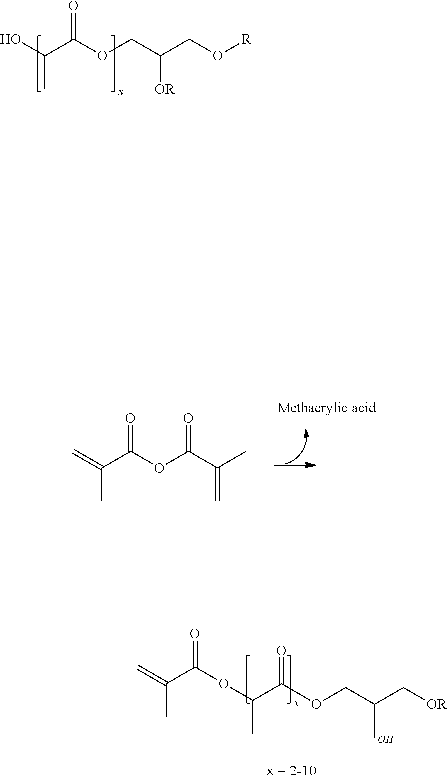

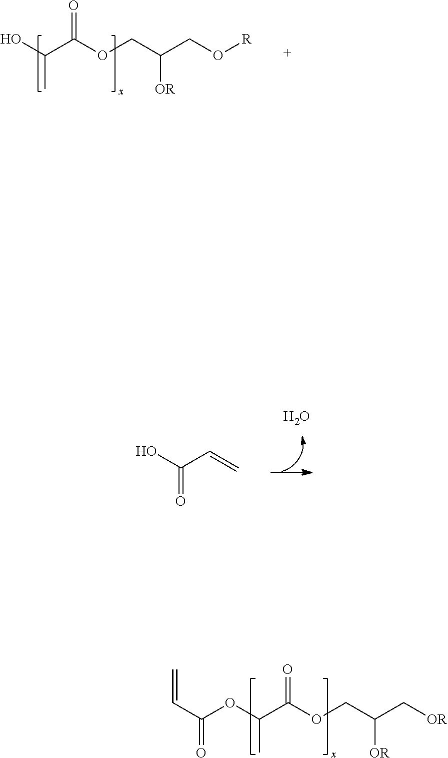

In an exemplary embodiment, step 102 of obtaining the solution may also include synthesizing an exemplary citric acid-based oligomer by pouring polyethylene glycol and citric acid into a vessel. In an exemplary embodiment, an exemplary vessel may be placed inside a microwave device. In an exemplary embodiment, citric acid and polyethylene glycol may be exposed to microwave radiation with a microwave power of between 100 W and 1000 W for 10 seconds to 60 seconds. In an exemplary embodiment, an exemplary temperature of an exemplary microwave device may be fixed between 110° C. and 140° C. In an exemplary embodiment, an exemplary process of microwave radiation may be repeated between 1 and 5 times. In an exemplary embodiment, an exemplary mixture of an exemplary citric acid and an exemplary polyethylene glycol may be mixed in an exemplary mixer after each microwave radiation process with a rotational speed of between 100 rpm and 300 rpm for 5 minute to 10 minutes to reach a temperature between 90° C. and 150° C. In an exemplary embodiment, polyethylene glycol and citric acid may be mixed with a weight ratio between 1:1 and 1:5 (citric acid:polyethylene glycol). In an exemplary embodiment, a catalyst may also be added into an exemplary reaction mixture of citric acid and polyethylene glycol. An exemplary catalyst may include a para-toluene sulfonic acid, triphenylphosphine, a para-toluene sulfuric acid, and methyl imidazole. In an exemplary embodiment, citric acid may form a core of an exemplary citric acid-based oligomer and polyethylene glycol may form branches of an exemplary citric acid-based oligomer.

In an exemplary embodiment, an exemplary citric acid-based oligomer may also be functionalized by adding a functionalizing agent to an exemplary citric acid-based oligomer. In an exemplary embodiment, an exemplary citric acid-based oligomer and an exemplary functionalizing agent may be exposed to microwave radiation with a radiation power of between 100 W and 400 W for 10 seconds to 60 seconds. In an exemplary embodiment, an exemplary process of microwave radiation may be repeated 1 to 5 times. In an exemplary embodiment, an exemplary citric acid-based oligomer may be heated in an exemplary microwave device at a temperature between 90° C. and 120° C. In an exemplary embodiment, an exemplary functionalizing agent may include methacrylic anhydride and acrylic acid. In an exemplary embodiment, an exemplary citric acid based oligomer may be mixed with an exemplary functionalizing agent with a weight ratio of between 1:1 and 1:6 (functionalizing agent:citric acid-based oligomer). In an exemplary embodiment, an exemplary reaction between polyethylene glycol and citric acid and also an exemplary reaction between an exemplary citric acid-based oligomer and acrylic acid as a functionalizing agent may be performed according to the following reactions:

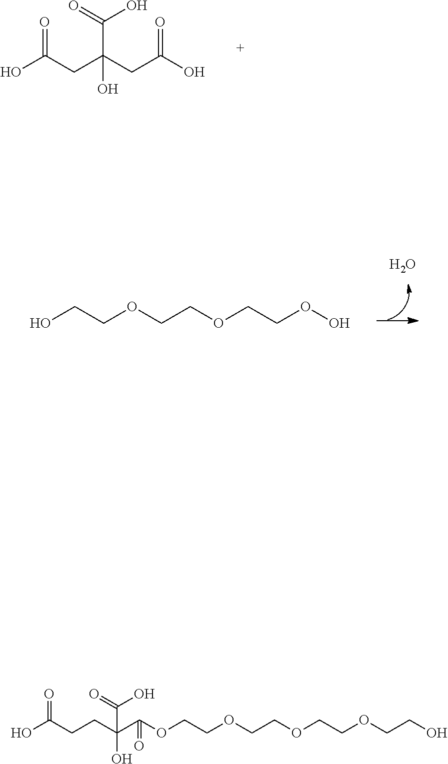 [SMILES: O=C(O)CC(O)(CC(=O)O)C(=O)O ; O ; OCCOCCOCCOO ; O=C(O)CCC(O)(C(=O)O)C(=O)OCCOCCOCCOCCO]

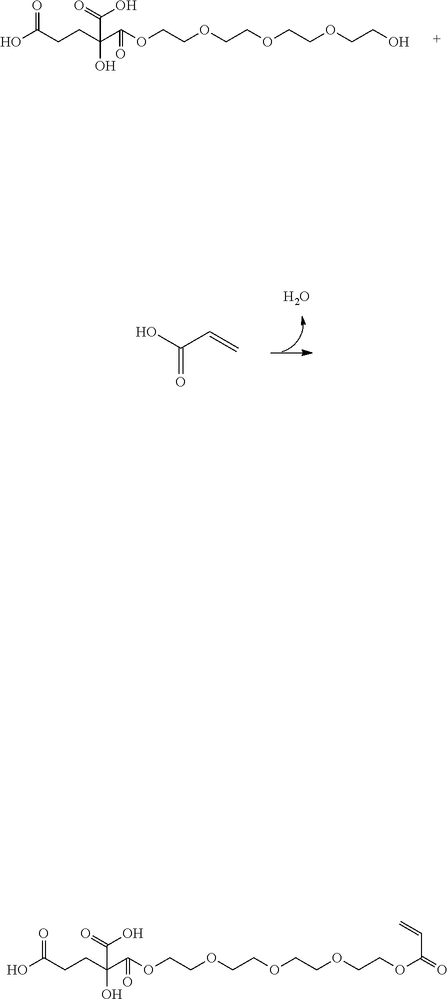

In an exemplary embodiment, step 102 of obtaining the solution may also include synthesizing an exemplary epoxy acrylate oligomer by pouring a catalyst and acrylic acid into a mixer. In an exemplary embodiment, an exemplary catalyst and acrylic acid may be mixed in an exemplary mixer with a rotational speed of between 100 rpm and 450 rpm for 5 minutes to 20 minutes to dissolve an exemplary catalyst in acrylic acid. In an exemplary embodiment, an exemplary catalyst and acrylic acid may be mixed with a weight ratio of between 100:0.2 and 100:1 (acrylic acid:catalyst). In an exemplary embodiment, an exemplary mixture of an exemplary catalyst and acrylic acid may be added to an epoxy oligomer. In an exemplary embodiment, an exemplary epoxy oligomer may be mixed with an exemplary catalyst and acrylic acid in an exemplary mixer with a rotational speed of between 100 rpm and 500 rpm for 10 minutes to 30 minutes. Then, an exemplary mixture of an exemplary catalyst, acrylic acid, and an exemplary epoxy oligomer may be exposed to microwave radiation with a power of between 250 W and 500 W for 15 seconds to 60 seconds. In an exemplary embodiment, an exemplary process of microwave radiation may be repeated 4 to 12 times. In an exemplary embodiment, an exemplary mixture of acrylic acid and an exemplary catalyst may be added to an exemplary epoxy oligomer with a weight ratio of between 1:2 and 1:5 (acrylic acid:epoxy oligomer). In an exemplary embodiment, epoxy groups of an exemplary epoxy oligomer may react with acrylic acid and epoxy groups may be converted to vinyl functional groups. In an exemplary embodiment, an exemplary reaction between an exemplary epoxy oligomer and acrylic acid may be performed according to the following reaction:

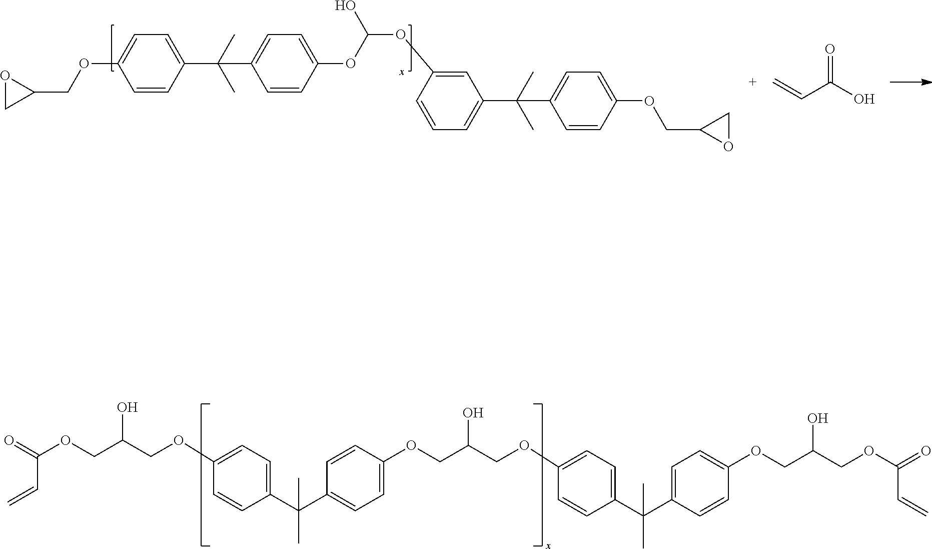

In an exemplary embodiment, step 102 may further include obtaining an exemplary solution by dissolving an exemplary functionalized oligomer in water and acetone in an exemplary mixer. In an exemplary embodiment, an exemplary functionalized oligomer may include a hydrophilic oligomer and a hydrophobic oligomer. In an exemplary embodiment, obtaining an exemplary solution may include mixing an exemplary hydrophilic oligomer and water in an exemplary mixer with a rotational speed of between 100 rpm and 350 rpm for 5 minutes to 15 minutes. In an exemplary embodiment, obtaining an exemplary solution may include adding an exemplary hydrophilic oligomer and water in an exemplary mixer with a weight ratio between 3:1 and 0.1:1 (hydrophilic oligomer:water). In an exemplary embodiment, after dissolving an exemplary hydrophilic oligomer in water, acetone may be added to an exemplary mixture of an exemplary hydrophilic oligomer and water with a weight ratio of between 0.1:1 and 2:1 (hydrophilic oligomer:acetone). In an exemplary embodiment, an exemplary mixture of an exemplary hydrophilic oligomer, water, and acetone may be stirred with a rotational speed of between 100 rpm and 350 rpm for 5 minute to 15 minutes.

In an exemplary embodiment, to obtain an exemplary solution, an exemplary hydrophobic oligomer and acetone may be mixed in an exemplary mixer with a rotational speed of between 100 rpm and 350 rpm for 5 minutes to 15 minutes. Obtaining an exemplary solution may include adding an exemplary hydrophobic oligomer and acetone with a weight ratio between 1:0.1 and 1:2 (hydrophobic oligomer:acetone). After dissolving an exemplary hydrophobic oligomer in acetone, water may be added to an exemplary mixture, then an exemplary mixture of an exemplary hydrophobic oligomer, water, and acetone may be stirred with a rotational speed of between 100 rpm and 350 rpm for 1 minute to 10 minutes. In an exemplary embodiment, water may be added to an exemplary mixture of hydrophobic oligomer and acetone with a weight ratio of between 0.2:1 and 1:1 (hydrophobic oligomer:water). In an exemplary embodiment, an exemplary hydrophilic oligomer may include an exemplary citric acid-based oligomer and an exemplary hydrophobic oligomer may include an exemplary lactic acid-based oligomer and an exemplary epoxy acrylate oligomer.

In an exemplary embodiment, to obtain an exemplary solution, an exemplary cross-linking agent, and an exemplary initiator may be mixed with an exemplary mixture of an exemplary functionalized oligomer, acetone, and water with a rotational speed of between 100 rpm and 300 rpm for 15 minutes to 45 minutes. In an exemplary embodiment, an exemplary initiator may include a hydrophilic initiator and a hydrophobic initiator, such as ammonium persulfate (APS), hydroperoxide (HP), and benzoyl peroxide (BP). In an exemplary embodiment an exemplary cross-linking agent may include poly(ethylene glycol) diacrylate (PEGDA). In an exemplary embodiment, an exemplary cross-linking agent may be added to an exemplary mixture of an exemplary functionalized oligomer, acetone, and water with a weight ratio of between 0.1:100 and 5:100 (cross-linking agent:functionalized oligomer). In an exemplary embodiment, an exemplary initiator may also be added to an exemplary mixture of an exemplary functionalized oligomer, acetone, and water with a weight ratio of between 0.05:100 and 5:100 (initiator:functionalized oligomer).

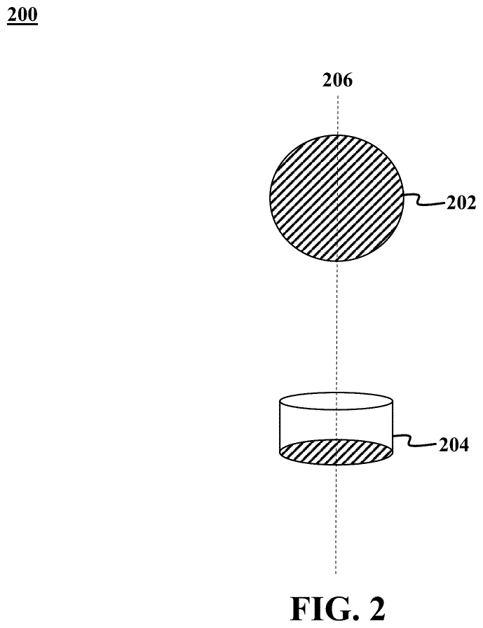

In an exemplary embodiment, step 104 of obtaining the molded superabsorbent polymer may include pouring an exemplary superabsorbent polymer in a die. FIG. 2 illustrates a schematic view of a die, consistent with one or more exemplary embodiments of the present disclosure. In an exemplary embodiment, FIG. 2 illustrates a top view 202 and a side view 204 of a die 200. In an exemplary embodiment, die 200 may have a disc shape. As used herein, an exemplary disc shape may refer to a closed circle base extending along a normal axis 206.

In an exemplary embodiment, after pouring an exemplary superabsorbent polymer in an exemplary die, an exemplary molded superabsorbent polymer may be heated at a temperature between 90° C. and 160° C. for 5 minutes to 120 minutes. In an exemplary embodiment, an exemplary die may include a disc die or a dumbbell die. In an exemplary embodiment, after pouring an exemplary superabsorbent polymer in die 200, an exemplary molded superabsorbent polymer may have a thickness of between 1 mm and 20 mm. In an exemplary embodiment, an exemplary superabsorbent polymer may have an average particle size of less than 150 sm. In an exemplary embodiment, an exemplary superabsorbent polymer may have a polymer with a water absorbing capacity of more than 100 g/g. As used herein, an exemplary absorbing capacity may refer to a total amount of an exemplary superabsorbent polymer weight with an exemplary absorbed aqueous solution weight to an exemplary superabsorbent polymer weight. In an exemplary embodiment, an exemplary superabsorbent polymer may include at least one of monomers selected from methacrylic acid, anhydrous maleic acid, itaconic acid, 2-acryloyl ethane sulfonic acid, 2-methacryloyl ethane sulfonic acid, 2-methacryloyl propane sulfonic acid, methacrylamide, 2-hydroxy ethyl methacrylate, 2-hydroxy propyl methacrylate, methoxy polyethylene glycol methacrylate, polyethylene glycol methacrylate, N, N-dimethyl amino ethyl methacrylate, acrylamide, maleic anhydride, carboxymethylcellulose, ethylene oxide, acrylonitrile, and N, N-dimethyl amino propyl methacrylamide.

In an exemplary embodiment, step 106 of impregnating the molded superabsorbent polymer with the solution may include adding dropwise a determined amount of an exemplary solution over an exemplary molded superabsorbent polymer with a weight ratio between 1:50 and 1:1 for 2 seconds to 120 seconds (solution:molded superabsorbent polymer). In an exemplary embodiment, an exemplary solution may be added dropwise to all surface areas of an exemplary molded superabsorbent polymer with an addition rate of 0.1 mL/s to 3 mL/s. In an exemplary embodiment, after an exemplary addition of an exemplary solution, an exemplary molded superabsorbent polymer may be impregnated with an exemplary solution for 5 minutes to 30 minutes. In an exemplary embodiment, an exemplary molded superabsorbent polymer may be heated after impregnating with an exemplary solution at a temperature between 90° C. and 160° C. for 5 minutes to 120 minutes. In an exemplary embodiment, exemplary functional groups of an exemplary functionalized oligomer may interact with an exemplary molded superabsorbent polymer to form a cross-linked superabsorbent polymer. In an exemplary embodiment, after the heating process, an exemplary cross-linked superabsorbent polymer may be grinded utilizing for example, a hammer mill to an average particle size of between 150 μm and 850 μm. As used herein, an exemplary hammer mill may refer to a mill with a drum containing a vertical or horizontal rotating shaft on which hammers may be mounted. In an exemplary embodiment, an exemplary hammer mill may include a sieve that may separate particles smaller than 850 μm, in an exemplary embodiment, an exemplary reaction between an exemplary backbone of an exemplary molded superabsorbent polymer and an exemplary functionalized oligomer may be performed according to the following reaction (O and I may represent oligomer and initiator, respectively):

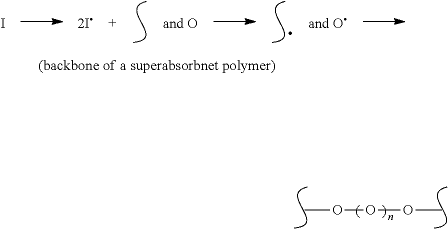

### Example 1: Synthesis of Lactic Acid-Based Oligomer

In this example, a method similar to method 100 may be used to produce lactic acid-based oligomer by mixing 0.5 mol glycerol, 2 mol L-lactic acid, and 0.1 wt. % of a para-toluene sulfonic acid as a catalyst. 80 g toluene may be added as an axillary solvent to remove produced water in a polycondensation reaction between L-lactic acid and glycerol. The reaction may be carried out at a temperature of 145° C. and the temperature may increase to 155° C. after 2 hours and the reaction may continue for another 2 hours under nitrogen atmosphere. For the final step, solvents may be removed from the reaction mixture utilizing a rotary evaporator at a temperature of 90° C. and a pressure of 120 mbar for 2 hours.

### Example 2: Functionalizing Lactic Acid-Based Oligomer by Methacrylic Anhydride (SM4)

In this example, a method similar to method 100 may be used to functionalize produced lactic acid-based oligomer. To this end, all the reactants may be transferred into a three-necked flask and a thermometer, a condenser, and a nitrogen line may be connected to the three-necked flask. 1.65 mol methacrylic anhydride may be added to the reactant mixture of example 1 with an addition rate of 70 mL/hour. The three-necked flask may be heated at 105° C. for 3 hours. An excess solvent may also be removed from the reaction mixture utilizing a rotary evaporator.

### Example 3: Functionalizing Lactic Acid-Based Oligomer by Acrylic Acid (SA4)

In this example, a method similar to method 100 may be used to functionalize lactic acid-based oligomers. To this end, all the reactants may be transferred into a three-necked flask and a thermometer, a condenser, and a nitrogen line may be connected to the three-necked flask. 1.65 mol acrylic acid may be added to the reactant mixture of example 1 with an addition rate of 70 mL/hour. The three-necked flask may be heated at 130° C. for 3 hours. An excess solvent may also be removed from the reaction mixture utilizing a rotary evaporator.

### Example 4: Synthesizing Citric Acid-Based Oligomer by Microwave Radiation (PC)

In this example, a method similar to method 100 may be used to synthesize citric acid-based oligomers. To synthesize citric acid-based oligomers, citric acid (bio-based material) and poly ethylene glycol (biocompatible material) may be used. The reaction may also be carried out by microwave radiation and no solvent. To synthesize citric acid-based oligomers, citric acid and polyethylene glycol may be mixed with a mol ratio of between 1:1, 1:2, and 1:3 (citric acid:polyethylene glycol). 0.1 mol citric acid. 0.1 mot polyethylene glycol, and a catalyst may be added into a vessel. The vessel may be placed inside microwave device and a microwave power of 450 W for 1 minute may be applied. The process of microwave radiation may be repeated three times and the temperature may be controlled at between 110° C. and 140° C. After passing 1 minute of radiation, the mixture may be transferred outside the microwave device and may be mixed to reach a temperature of 110° C., This process may be repeated three times.

In this example two kinds of polyethylene glycol with different molecular weights of 200 and 400) may be used, which is referred to herein as PC2 and PC4, respectively.

### Example 5: Functionalizing Citric Acid Based Oligomer by Acrylic Acid (PCA)

In this example, a method similar to method 100 may be used to functionalize citric acid-based oligomers. To this end, acrylic acid may be added to the reaction mixture of example 4. The mixture may be exposed to microwave radiation with a microwave radiation power of 250 W at a temperature of between 90° C. and 120° C. In this example to synthesis PCA, polyethylene glycol with the molecular weight of 200 may be used which is abbreviated as PCA2.

### Example 6: Synthesizing Epoxy Acrylate Oligomer by Microwave Radiation (VER)

In this example, a method similar to method 100 may be used to synthesize epoxy acrylate. To this end, three phenyl phosphine may be dissolved in acrylic acid and then may be added to an epoxy resin. The mixture may be exposed to microwave radiation with a microwave power of 45 W at a temperature between 110° C. and 150° C. This process may be repeated 10 times. Table 1 shows the data of superabsorbent polymers interconnected by different functionalized oligomers, consistent with one or more exemplary embodiments of the present disclosure.

TABLE 1

| | Solution | | | | | Recovering superabsorrbent | | | |
|---|---|---|---|---|---|---|---|---|---|
| | | | Organic | | | Super | | | |
| Sample | Oligomer | Water | solvent | | | absorbent | Temperature | Time | |
| name | (g) | (g) | (g) | Additive | Initiator | particles (g) | (° C.) | (h) | Appearance |
| VE501 | VER (3 g) | 3 | 3 | PEGDA | BP | 5 | 100 | 2 | Opaque |
| | | | | (0.03 g) | (0.05 g) | | | | solution |
| | | | | | | | | | without any |
| | | | | | | | | | settlement |
| APC501 | PC2 | 2.5 | 2.5 | AS | — | 4.5 | 100 | 2 | Clear |
| | (2.5 g) | | | (0.25 g) | | | | | solution |
| | | | | MI | | | | | |
| | | | | (0.1 g) | | | | | |
| PC2501 | PC2 | 3 | 3 | PTSA | — | 6 | 120 | 1.5 | Clear |
| | (3 g) | | | (0.015 g) | | | | | solution |
| PC450 | PC4 | 3 | 3 | Amido | — | 6 | 120 | 1.5 | Clear |
| | (3 g) | | | sulfonic | | | | | solution |
| | | | | acid | | | | | |
| | | | | (0.036 g) | | | | | |
| PCA501 | PCA2 | 3 | 3 | PEGDA | APS | 5 | 100 | 2 | Clear |
| | (3 g) | | | (0.025 g) | (0.1 g) | | | | solution |
| PCA701 | PCA2 | 2 | 4 | PEGDA | HP | 6 | 120 | 1.5 | Clear |
| | (2 g) | | | (0.06 g) | (0.02 g) | | | | solution |
| SMA41 | SM4 | 1.8 | 4.2 | PEGDA | BP | 6 | 120 | 2 | Clear |
| | (2 g) | | | (0.03 g) | (0.05) | | | | solution |
| SMA41 | SA4 | 1.8 | 4.2 | PEGDA | BP | 6 | 120 | 2 | Clear |
| | (2 g) | | | (0.03 g) | (0.05 g) | | | | solution |

### Example 7: Preparing Superabsorbent Polymer Samples for Analysis

To prepare superabsorbent polymer samples, the impregnated superabsorbent polymer may be compressed with a pressure of between 0 and 0.9 psi on the top surface of the molded superabsorbent polymer along the normal axis of the top surface for 0 to 2 hours. The prepared superabsorbent polymer samples may be used for analyzing mechanical properties of the prepared superabsorbent polymer samples.

To analyze prepared samples, the amount of deionized water absorbance (Q_{DW}), sodium chloride solution absorbance (Q_{S}), absorbent under pressure in sodium chloride solution (AUL), primary recycling efficiency (R₁), secondary recycling efficiency (R₂), and elastic modulus at 1 rad's (G′) may be tested. R₁ may show the variation in weight of the cross-linked superabsorbent polymer before and after the impregnation. R₂ may show the weight of the particles larger than 150 μm to the weight of the particles before the grinding process. The equations for calculating R₁ and R₂ are shown below:

$${R}_{1} = \frac{weight of the impregnated superabsorbent polymer}{weight of the molded superabsorbent polymer} \times 100$$

$${R}_{2} = \frac{\begin{matrix}weight of superabsorbent polymer \\ particles of more than 150 μm\end{matrix} }{\begin{matrix}weight of superabsorbnet polymer \\ particles before grinding\end{matrix} } \times 100$$

Table 2 illustrates results of efficiency analysis of the produced samples, consistent with one or more exemplary embodiments of the present disclosure. In this example, SAP is referred to a superabsorbent polymer.

TABLE 2

| | | | Q_{DW} | AUL | | | |
|---|---|---|---|---|---|---|---|
| Experiment | Code | Q₁ (g/g) | (g/g) | (g/g) | G′ (Pa) | R₁ (%) | R₂ (%) |
| | Fine | 38.4 | 285.3 | 8.1 | 769 | — | — |
| | SAP | | | | | | |
| 1 | VE501 | 18.7 | — | 6.6 | 1270 | 147 | 96 |
| 2 | APC501 | — | — | — | — | 136 | — |
| 3 | PC2501 | 23.1 | 143.5 | 6.0 | 325 | 128 | 96 |
| 4 | PC4501 | 26.3 | 156.4 | 6.3 | — | 124 | 100 |
| 5 | PCA501 | 21.0 | — | 4.0 | — | 148 | 99 |
| 6 | PCA701 | 29.7 | 184.7 | 4.4 | 726 | 96 | 67 |
| 7 | SM41 | 33.0 | 213.3 | 12.8 | 877 | 117 | 60 |
| 8 | SA41 | 30.0 | 210.2 | 4.3 | 563 | 114 | 85 |

FIG. 3 illustrates an attenuated total reflectance-Fourier transform infrared spectroscopy (ATR-FTIR) image of functionalized oligomers, consistent with one or more exemplary embodiments of the present disclosure. ATR-FTIR analysis may confirm the surface modification of the samples. ATR-FTIR analysis may be performed in a wavenumber of between 600-4000 cm⁻¹ with the resolution of 1 cm⁻¹. ATR-FTIR pattern 302, 304, 306, 308, 310, and 312 correspond to ATR-FTIR results of VE501, PC2501, PCA701, SA41, SM41, and fine particles, respectively.

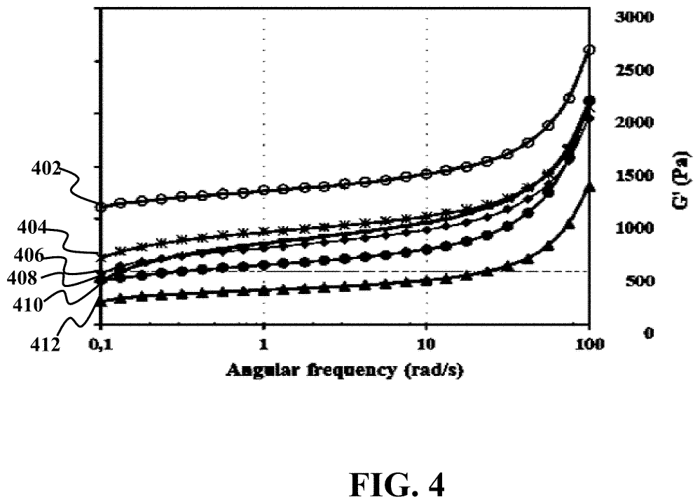

FIG. 4 illustrates storage (G′) moduli of superabsorbent polymers interconnected by different functionalized oligomers, consistent with one or more exemplary embodiments of the present disclosure. Storage of the produced samples may be recorded as a function of frequency at a constant shear strain of 0.2%. In this regard, 0.2 g of the samples may be added to 0.5 g deionized water. Storage (G′) pattern 402, 404, 406, 408, 410, and 412 correspond to storage (G′) results of VE501, SM41, PCA701, fine SA particles, SA41, and PC2501, respectively.

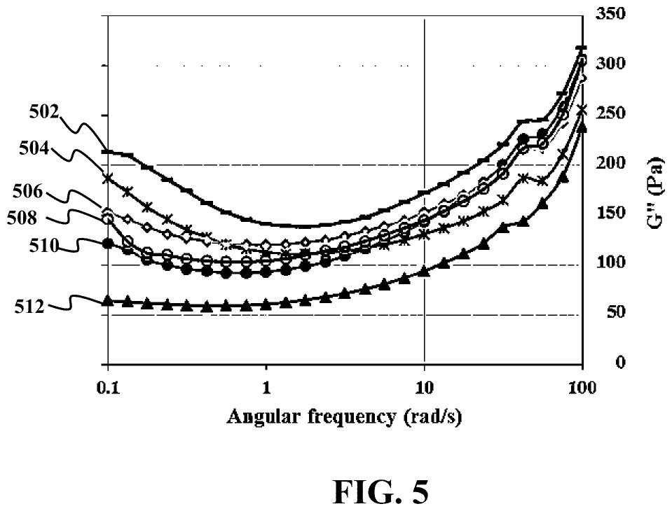

FIG. 5 illustrates loss (G″) moduli of superabsorbent polymers interconnected by different functionalized oligomers, consistent with one or more exemplary embodiments of the present disclosure. Loss of the produced samples may be recorded as a function of frequency at a constant shear strain 0.2%. In this regard, 0.2 g of the samples may be added to 0.5 g deionized water. Loss (G′) pattern 502, 504, 506, 508, 510, and 512, correspond to loss (G″) results of fine SA particles, SM41, PCA701, VE501, SA41, and PC2501, respectively.

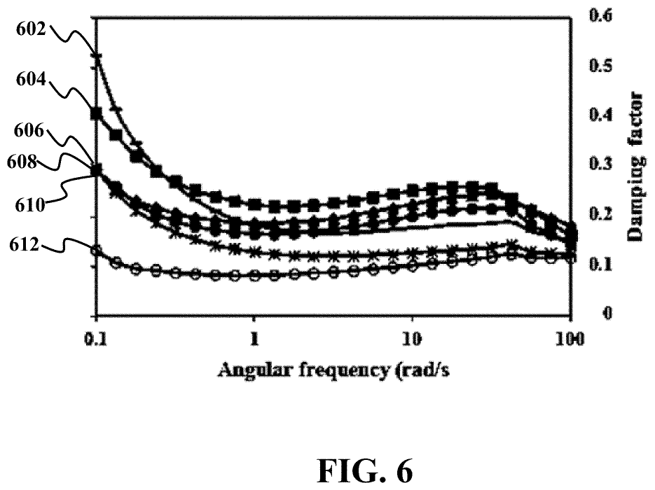

FIG. 6 illustrates a damping factor of superabsorbent polymers interconnected by different functionalized oligomers, consistent with one or more exemplary embodiments of the present disclosure. Damping-factor pattern 602, 604, 606, 608, 610, and 612 correspond to damping factor results of fine SA particles, PCA701, PC2501, SA4, SM41, and VE501, respectively.

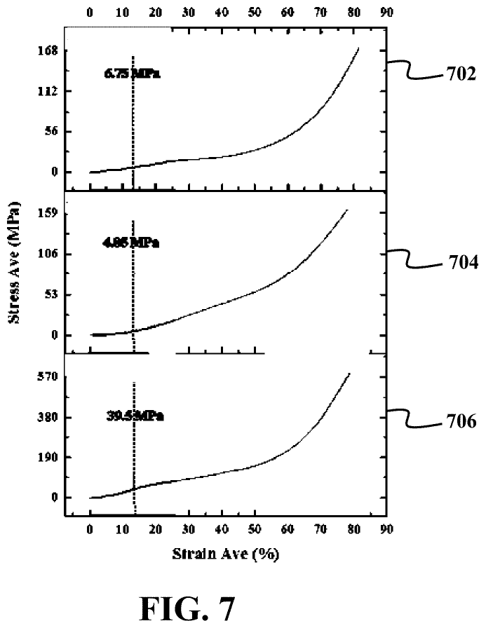

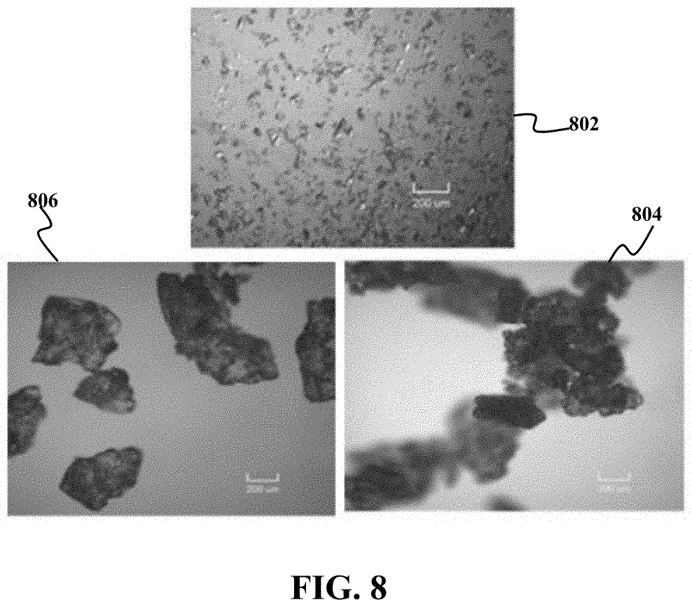

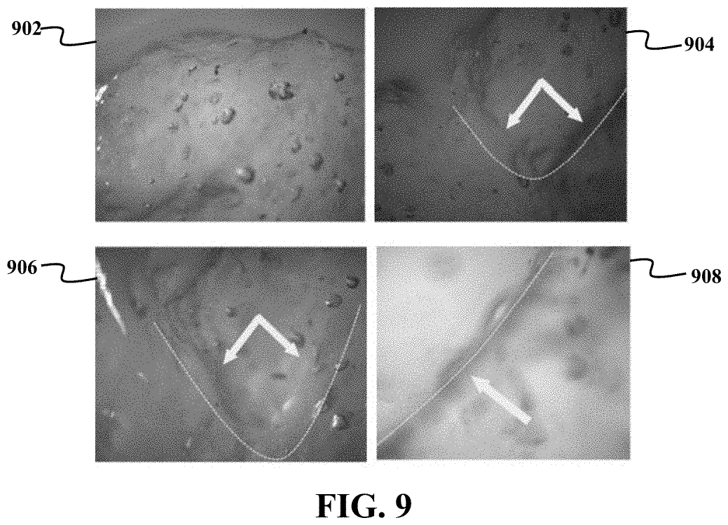

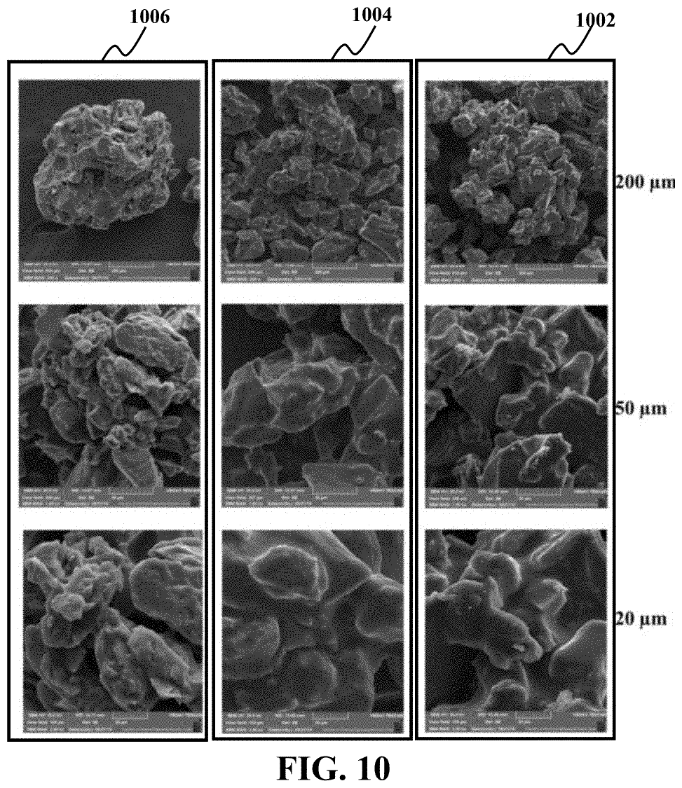

FIG. 7 illustrates a compressive stress versus a strain of superabsorbent polymers interconnected by different functionalized oligomers, consistent with one or more exemplary embodiments of the present disclosure. The compressive strain of the lactic acid-based oligomers at 39.5 MPa and 4.85 MPa may be shown in FIG. 7. The recovery efficiency of sample SA41 may be more than sample SM41. Sample SM41 may show better absorbance and strength properties. The sample based on polyethylene glycol and citric acid may show 99% recovery efficiency with moderate absorbance efficiency and 6.75 MPa strength properties. FIG. 7 may show compressive stress versus strain of sample 702, 704, and 706 corresponding to PCA501, SM41, and SA41, respectively.

FIG. 8 illustrates optical microscope images of superabsorbent polymers interconnected by different functionalized oligomers, consistent with one or more exemplary embodiments of the present disclosure. Optical microscope images may show cross linking of the superabsorbent particles. Image 802, 804, and 806 may show SEM images of pristine fine superabsorbent polymer particles, modified superabsorbent polymer particles by SM41, and modified superabsorbent polymer particles by SA41, respectively.

FIG. 9 illustrates optical microscope images of swollen and modified superabsorbent polymer particles, consistent with one or more exemplary embodiments of the present disclosure. FIG. 9 shows optical microscope images 902, 904, 906, and 908 of the SA41 sample with the magnification of 40×, 40×, 80×, and 160×, respectively. In FIG. 9, weld lines may be shown for better illustrations.

FIG. 10 illustrates SEM images of functionalized superabsorbent polymer particles, consistent with one or more exemplary embodiments of the present disclosure. Images 1002, 1004, and 1006 may show SEM images of PCA-functionalized superabsorbent polymers (PCA501), SA41-functionalized superabsorbent polymers, and SM41-functionalized superabsorbent polymers, respectively at various magnifications.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps. Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “vertical”, “horizontal”, “up” “down”, and “side-to-side” are used in a relative sense to the normal orientation of the apparatus.

What is claimed is:

1. A method for producing a cross-linked superabsorbent polymer, the method comprising:
obtaining a solution by mixing a cross-linking agent, an initiator, water, acetone, and at least one of a lactic acid-based oligomer, a citric acid-based oligomer, and an epoxy acrylate oligomer;
molding a superabsorbent polymer by pouring the superabsorbent polymer with an average particle size of less than 150 μm into a die, the superabsorbent polymer comprising a polymer with a water absorbing capacity of more than 100 g/g; and
impregnating the molded superabsorbent polymer with the solution by adding the solution to the molded superabsorbent polymer in a drop-wise manner with a weight ratio between 1:1 and 50:1 (molded superabsorbent polymer:the solution).

2. A method for producing a cross-linked superabsorbent polymer, the method comprising:
obtaining a solution by mixing a cross-linking agent, an initiator, water, acetone, and a functionalized oligomer;
obtaining a molded superabsorbent polymer by molding the superabsorbent polymer in a die, the superabsorbent polymer comprising a polymer with a water absorbing capacity of more than 100 g/g; and
impregnating the molded superabsorbent polymer with the solution by adding the solution to the molded superabsorbent polymer.

3. The method of claim 2, wherein mixing the cross-linking agent, the initiator, water, acetone, and the functionalized oligomer comprises mixing the cross-linking agent, the initiator, water, acetone, and at least one of a citric acid-based oligomer and an epoxy acrylate oligomer.

4. The method of claim 3, wherein obtaining the solution comprises mixing the cross-linking agent, the initiator, water, acetone, and the functionalized oligomer in a mixer with a rotational speed of between 100 rpm and 300 rpm for 15 minutes to 45 minutes.

5. The method of claim 4, wherein the solution comprises mixing the cross-linking agent, the initiator, water, acetone, and the functionalized oligomer with a weight ratio of the initiator to the functionalized oligomer between 0.05:100 and 5:100 (initiator:functionalized oligomer).

6. The method of claim 5, wherein the solution comprises mixing the cross-linking agent, the initiator, water, acetone, and the functionalized oligomer with a weight ratio of the cross-linking agent to the functionalized oligomer between 0.1:100 and 5:100 (cross-linking agent:functionalized oligomer).

7. The method of claim 6, wherein obtaining the solution further comprises synthesizing functionalized oligomers by applying thermal energy and microwave radiation to the reactants of the functionalized oligomer synthesis process.

8. The method of claim 7, wherein the initiator comprises ammonium persulfate, hydroperoxide, and benzoyl peroxide.

9. The method of claim 8, wherein the cross-linking agent comprises poly(ethylene glycol) diacrylate.

10. The method of claim 9, wherein obtaining the solution further comprises mixing the cross-linking agent, the initiator, water, acetone, and the functionalized oligomer with a catalyst, wherein the catalyst comprises at least one of a para-toluene sulfonic acid, triphenylphosphine, a para-toluene sulfuric acid, and methyl imidazole.

11. The method of claim 2, wherein molding the superabsorbent polymer comprises pouring the superabsorbent polymer with an average particle size of less than 150 μm into the die.

12. The method of claim 11, wherein molding the superabsorbent polymer comprises obtaining the molded superabsorbent polymer with a thickness of between 1 mm and 20 mm.

13. The method of claim 2, wherein impregnating the molded superabsorbent polymer with the solution comprises adding the solution to the molded superabsorbent polymer in a drop-wise manner with a weight ratio between 1:1 and 50:1 (molded superabsorbent polymer:the solution).

14. The method of claim 13, wherein impregnating molded superabsorbent polymer with the solution comprises adding the solution to the molded superabsorbent polymer in a dropwise manner during a period in a range of 2 to 120 seconds.

15. The method of claim 14, wherein impregnating molded superabsorbent polymer with the solution comprises adding the solution to the molded superabsorbent polymer with an addition rate of 0.1 mL/s to 3 mL/s.

16. The method of claim 15, wherein impregnating molded superabsorbent polymer with the solution comprises impregnating the molded superabsorbent polymer with the solution for 5 minutes to 30 minutes.

17. The method of claim 16, wherein impregnating molded superabsorbent polymer with the solution comprises heating the molded superabsorbent polymer and the functionalized oligomer in a range of 90° C. and 160° C.

18. The method of claim 17, wherein impregnating molded superabsorbent polymer with the solution comprises heating the molded superabsorbent polymer and the functionalized oligomer for 5 minutes to 120 minutes.
